(19) United States
(12) Patent Application Publication
(10) Pub. No.: US 2006/0257198 A1
(43) Pub. Date: Nov. 16, 2006

(54) Combination of a writing device and a clamping device

(76) Inventor: Bob Roeloffs, Amsterdam (NL)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/551,278

(22) PCT Filed: Mar. 24, 2004
(86) PCT No.: PCT/IB04/50355

§ 371 Date: Sep. 28, 2005

(30) Foreign Application Priority Data
Mar. 28, 2003 (NL) 102035

(51) Int. Cl. B43K 23/02; B43K 29/00

(52) U.S. Cl. 401/131; 401/195; 401/52

(57) ABSTRACT

The invention relates to a combination of a writing, drawing or marking device with a clamping device for the fastening to or holding together of flat materials among which, but not limited to, sheets of paper. The housing has a predominantly flat character allowing for easy positioning in between a book without this causing large deformations to the book. The combination can also be used as a bookmark device e.g. for use in a book.

The invention relates to a writing device or drawing device combined with a device which can be used as a bookmark device e.g. for use in a book or as a device for the fastening to or holding together flat materials among which, but not limited to, sheets of paper.

Writing devices, among which text markers and pens, are often used in combination with writeable materials among which books and papers. Generally the writing devices are carried loose with the writeable materials. Because of this, writing devices are frequently misplaced, lost or forgotten. Writing devices are also frequently placed or folded within books. This often causes undesired deformations to books because writing devices generally have a relatively large thickness.

Some writing devices have a clip which consists of a generally approximately three to five centimetres long lip which at one end is attached to a part of the writing device and which on the other end resiliently presses against a part of the writing device. Between these parts of the writing device, which press against each other, an amount of sheets of paper can be clamped. If the writing device is clamped onto e.g. pages in a book, however, then because of the orientation of the clamped writing device relative to the book, the thickness of the writing device will increase with the bulge, or the thickness of the lip, thereby increasing the deformation of the book. The base form of the book is seen here as closed and desirable during transport. Also the temporary connection between writing devices and books or paper is regularly considered insufficiently strong. The writing device may detach too easily and not always hold several loose sheets together with sufficient firmness.

This invention seeks to resolve these discomforts by means of a partially flattened profile and by a new way of causing a temporary connection between writing devices and flat materials such as, but not limited to, books, stencils or sheets of paper.

### Prior Art

U.S. Pat. No. 1,810,109 describes a combination of a pencil with a clamping device. The clamping device comprises two U-shaped clamping parts which at the ends of the legs thereof are pivotably connected with a hinge axis which is attached to the end of the pencil facing away from the writing tip of the pencil. During storage of the combination the pencil with the writing tip thereof is situated in the area of the clamping parts, and the pencil is placed between two ply parts of a card, whilst the clamping parts are each placed on opposite sides of the ply parts. During use of the combination the combination is removed from between the ply parts, and the pencil is pivoted 180° relative to the clamping parts, thereby allowing writing with the pencil.

The invention in this application, when compared to McEnery, proposes a combination of a writing device and a clamping device, in which there is no movable connection between the writing device and the clamping device. In addition the writing tip of the writing device is situated, in principle, in the use situation and in the stown away situation of the combination outside of the area of the clamping device. Conversely, the body member of the writing device is always located within the area of the clamping device in order to create the desired clamping: in the clamping, both the body member of the writing device and the clamping device play a part.

### Idea Description

The invention combines three devices in one product. These three devices are a clamping device, a bookmark device and a writing, drawing or marking device.

The clamping device provides the possibility to temporarily connect the invention with the edge area of flat materials. Furthermore the clamping device also provides the possibility to hold together several flat materials through clamping. Under the clampable materials all products or materials with which an attachment is conceivable fall. In daily use this shall apply among other things for office and school articles such as paper, cardboard, plastic, books, exercise books, notebooks. Furthermore handles and straps of bags or satchels or other parts of clothing. Under ‘clampable’ materials in principle any material and or shape that could partially or as a whole fit in the clamping fall.

With the bookmark device a device is intended which can be used to indicate where a user left off in a book, exercise book or notepad by the positioning therein of the device. It is desirable with such devices that the book does not deform too much. A relatively flat shape is desired.

The writing, drawing or marking device provides the possibility to place text, colour or shapes on a material. In daily use this is usually paper, cardboard or plastic, whether or not coated.

In everyday life, such as in the office, at school and at home these devices are used in varying degree. A combination of these devices has a number of advantages. The user needs to carry less products. In addition the added value of the writing device increases. It shall less quickly be misplaced, forgotten or lost. Furthermore the invention provides a good opportunity for advertisement or promotional purposes. The invention provides the opportunity to be printed with e.g. corporate logos, names and the like and to be used as promotional gift. The invention, through the combination of devices and the resulting product form, acquires a high ‘gimmick’ quality.

### DESCRIPTION OF THE DRAWINGS

In the following the invention is further explained by means of a number of non restricting examplary embodiments whereby:

FIG. 1A shows a view in perspective of a first embodiment of a combination according to the invention;

FIG. 1B shows a front view of the combination according to FIG. 1A;

FIG. 1C shows a side view of the combination according to FIG. 1A;

FIG. 1D shows a cross-sectional view of the flattened character of a part of the combination according to FIG. 1A;

FIG. 2 shows a perspective view of the combination according to FIG. 1A, placed in a book;

FIG. 3A shows a perspective view of a variation of the first embodiment of a combination according to the invention, with a different length and width ratio;

FIG. 3B shows a side view of the combination according to FIG. 3A;

FIG. 4 shows a top view of a second variation of the first embodiment of a combination according to the invention, with yet another length and width ratio;

FIG. 5 shows a top view of a second embodiment of a combination according to the invention;

FIG. 6 shows a top view of a third embodiment of a combination according to the invention;

FIG. 7 shows a perspective view of an embodiment of a combination according to the invention, composed of several materials/parts;

FIG. 8A shows a perspective view of an embodiment of a combination according to the invention, composed of several materials/parts;

FIG. 8B shows a side view of the combination according to FIG. 8A;

FIG. 9A shows a perspective view of a fourth embodiment of a combination according to the invention, wherein the clamping device is detachable from the writing device;

FIG. 9B shows an exploded perspective view of the combination according to FIG. 9A;

FIG. 9C shows a side view of the combination according to FIG. 9A;

FIG. 9D shows an exploded perspective view of the combination according to FIG. 9A, with an open variant of the clamping device;

FIG. 9E shows a perspective view of a different variant of the clamping device according to FIG. 9D;

FIG. 9F shows a perspective view of a different variant of the clamping device according to FIG. 9D;

FIG. 9G shows a perspective view of a clamping device according to FIG. 9A, composed of several materials/parts;

FIG. 9H shows a perspective view of a clamping device according to FIG. 9G, with detached parts;

FIG. 10 shows a perspective view of an embodiment of a combination according to the invention, in which the clamping device is detachable;

FIG. 11A shows a perspective view of an embodiment of a combination according to the invention, in which the clamping device is combinable with a separate writing device, disengaged;

FIG. 11B shows a second perspective view of an embodiment of a combination according to FIG. 11A, engaged;

FIG. 12A shows a perspective view of a variation of the embodiment of a combination according to the invention, in which the clamping device is combinable with a separate writing device, disengaged;

FIG. 12B shows a second perspective view of an embodiment of a combination according to FIG. 12A, engaged;

FIG. 12C shows a side view of an embodiment of a combination according to FIG. 12A, engaged;

FIG. 13A shows a perspective view of an embodiment of a combination according to the invention, in which a clamping device is combinable with a separate writing device, disengaged;

FIG. 13B shows a second perspective view of an embodiment of a combination according to FIG. 13A, engaged;

FIG. 13C shows a front view of a embodiment of a combination according to FIG. 13A, engaged;

FIG. 14 shows a perspective view of an embodiment of a combination according to the invention;

FIG. 15A shows a perspective view of a third variation of the first embodiment of a combination according to the invention;

FIG. 15B shows a side view of the combination according to FIG. 15A;

FIG. 16 A shows a perspective view of an embodiment of a combination according to the invention, in which the cap of the writing device is integrated in de clamping device and this entity is detachable from the writing device, engaged, or slid into each other;

FIG. 16B shows a perspective view of an embodiment of a combination according to FIG. 16A, disengaged, or slid apart;

FIG. 17A shows a perspective view of an embodiment of a combination according to the invention, in which the cap of the writing device is temporarily connected to the clamping device and this entity is detachable from the writing device, disengaged, or slid apart;

FIG. 17B shows a front view of an embodiment of a combination according to FIG. 17A, engaged, or slid into each other;

FIG. 18 shows a perspective view of an embodiment of a combination according to the invention, in which several writing devices are combined with the clamping device;

FIG. 19 shows a perspective view of a second variation of an embodiment of a combination according to the invention, in which several writing devices are combined with the clamping device;

FIG. 20 shows a perspective view of an embodiment of a combination according to the invention, in which the clamping device is pivotable;

FIG. 21 shows a perspective view of an embodiment according to FIG. 20, in which a disengagable clamping device is partially open;

FIG. 22 shows a perspective view of an embodiment of a combination of a bookmark device with several writing devices.

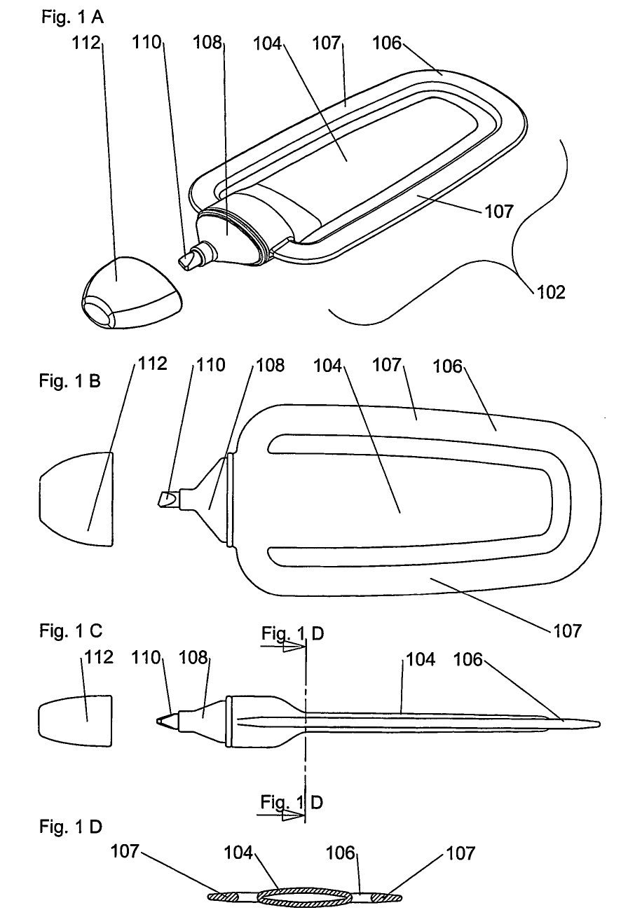

The invention consists of a holder which, inter alia, can be manufactured from a synthetic material. This holder contains, possibly in combination with extra components, the devices described in this invention. The invention will now be described by means of several embodiments. The invention is, however, not limited to these embodiments. In these embodiments, to illustrate a writing device, a non-limiting highlighter marker has been chosen. A writing device could also comprise, but is not limited to, pencil, ball pen, cartridge, felt-tip, fine-liner, marker, scent pen, fountain pen, wasco, correction liquid such as Tipp-Ex®, glue-pen, paint-pen, etcetera. The holders in these embodiments are therefore equipped with a writing tip (indicated in FIGS. 1A, 1B en 1C as 110). Furthermore there is possibly a cap (indicated in FIGS. 1A, 1B and 1C as 108) to seal the holder and position the writing tip. De highlighter marker is also equipped with a cap (indicated in FIGS. 1A, 1B and 1C as 112) to prevent the writing tip from drying out, damage or unintended running. (The design of the interior including the ink reservoir will not be discussed further here.)

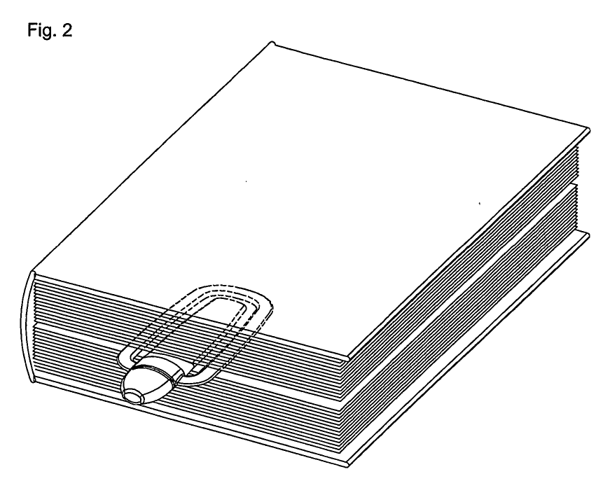

The holder 102 in the first embodiment (represented inter alia in the FIGS. 1A, 1B, 1C, 1D and 2) comprises a writing member 104 around which a clamping device 106 lies. This clamping device is subdividable into two elongated leg parts 107 which each on an outer end thereof are connected to the writing member and on the other outer ends are joined together. De two leg parts in this embodiment lie substantially parallel to an edge facing the legs of the writing member. It is, however, also conceivable that the legs do not lie parallel to an edge facing the legs of the writing member but that the distance varies. In this embodiment the writing member and de leg parts consist of one part and take a fixed position relative to each other. These body members together lie essentially in one plane at rest. (This is the position in which no temporary connection or interaction has been made yet with the material with which a temporary connection is intended.) The two body members can be slid over the edge of paper (or other material which is thin enough). With this, the writing member and the leg parts are bent apart and positioned on both sides of the material sliding in-between. Through the bending apart of the body members tensions arise in the material of the body members. These tensions are relatively large where the legs are joined to the writing member. Because of these tensions the body members have the tendency to want to bend back toward each other. The body members want to return to the position and orientation of the rest orientation. The in-between material (inter alia in the case of several sheets of paper) prevents this partially and is partially deformed as well. The pressure that the body members exert on the in-between material results in a frictional force as a result of which the body members and the in-between material stay joined together. The pressure which the body members on both sides of the in-between material exert on the in-between material is exactly opposite and in equilibrium.

FIG. 1C clearly shows a relatively flat part of the invention, to the right of the line double indicated with ‘FIG. 1D’. This part of the invention is the part that is intended to be positioned between pages of a book without this causing to great a deformation to the book (but is not limited to this use).

FIG. 1D illustrates a cross-sectional view of the relatively flat part of the writing member 104. The part of the writing member lying between the legs 107 of the clamping device 106 is depicted hollow here. This part could also be solid and is not limited to the design options mentioned here. The part of the writing member falling in-between the book in FIG. 2 can therefore be hollow as well as solid but is not limited to this.

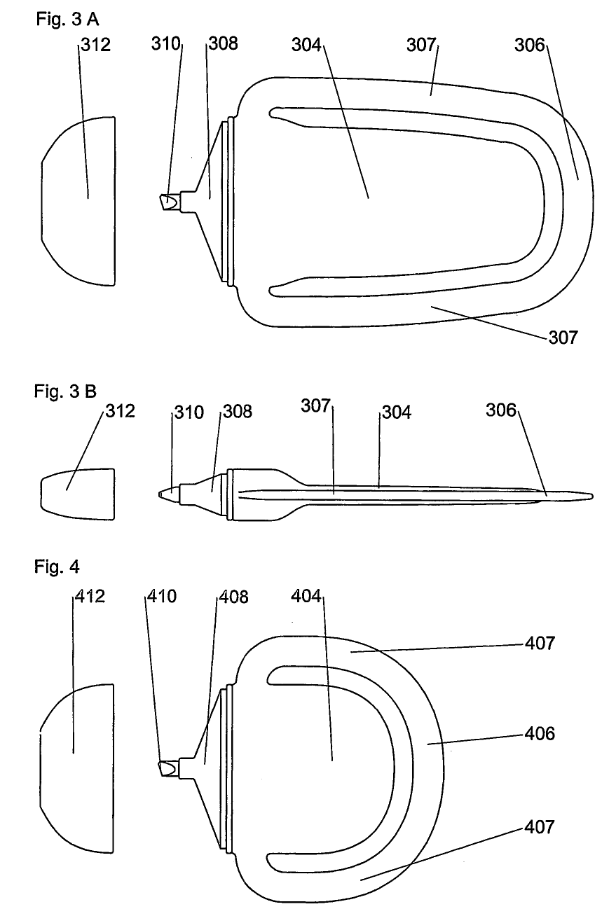

The character of the invention changes in FIGS. 3A, 3B and 4 optically but the principle of operation does not. 304 and 404 show the writing member, and 306 and 406 show the clamping device comprising leg parts 307 and 407. 308 and 408, 310 and 410 and 312 and 412 respectively show once again the top seal, the writing tip and the cap.

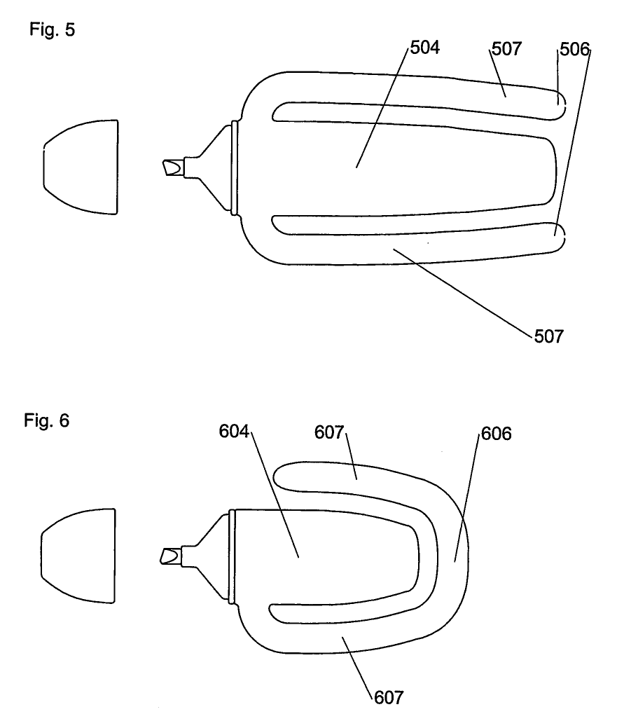

A second non-limiting embodiment (FIG. 5) shows that the clamping device 506 does not have to consist of legs which are joined together at an end. It may consist of several legs 507 which individually show no overlap with the writing member 504 but can be considered as a collection of leg parts which with their combined circumference do show overlap with the writing member.

As shown by the embodiments in FIG. 5 and FIG. 6, the leg parts 507, 607 do not need to enclose the writing member 504, 604 entirely. In these examples however it is necessary that at least a part of the circumference of the leg parts (that is, the clamping device) should overlap with a part of the writing member. The clamping device in FIG. 6 according to the description consists of two leg parts of which the two outer ends of the leg parts are joined together and only one outer end of a leg is connected to the writing member. It could, however, also be described as a clamping device consisting of a leg part which at an end is connected to the writing member and at the other end is free and can move. The formulation of the clamping device (comprising at least a leg) is not limited to the variations mentioned in this invention. FIG. 6 somewhat resembles an ‘@’ character. This can be enhanced in design and variations on this are therefore also covered by the invention.

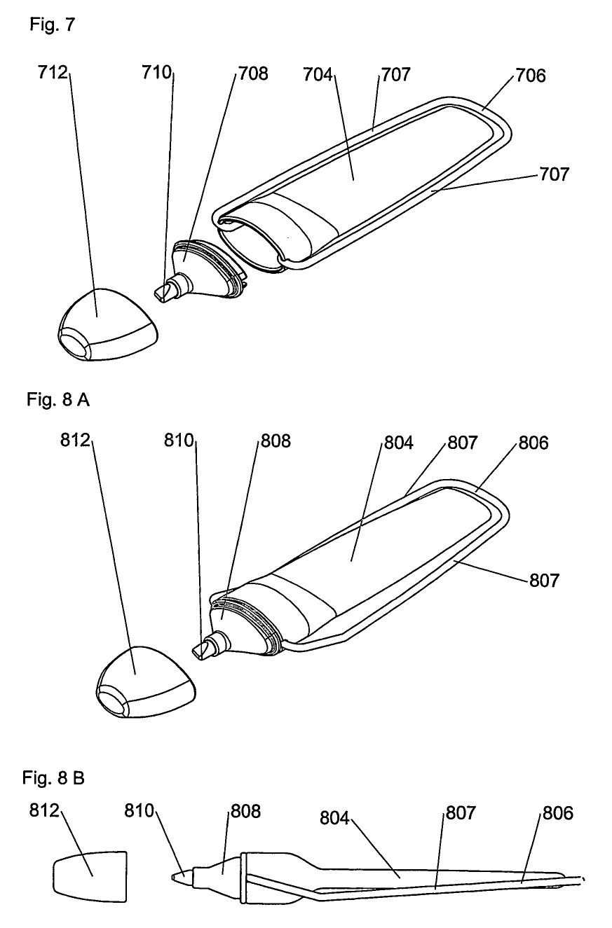

In the embodiments described previously, the writing member and the clamping device (that is, the leg parts) consist of a part. This part could be injection moulded. These body members could however also consist of several parts such as depicted in FIG. 7. This has several advantages. Different materials could be used for the writing member and the clamping device (that is, the leg parts). Conceivable is, inter alia, a writing member of synthetic material and a clamping device of a metal. In this way a production, usage or aesthetic consideration can lead to the construction of the holder, comprising a writing member and a clamping device, from more than one part. The possible embodiments are not limited by the considerations mentioned above. FIG. 7 shows an embodiment consisting of a writing member 704 consisting of e.g. a plastic and a clamping device 706 (comprising a first leg and possibly several leg parts 707) consisting e.g. of metal.

In the previously described embodiments the clamping device, comprising a first and possibly second or several leg parts, is constructed in practically the same plane as the writing member. It is, however, also conceivable that the planes of the clamping device 806 (comprising leg parts 807) and the writing member are shifted relative to each other (FIGS. 8A and 8B). This could allow thicker material to be clamped. It however has a detrimental effect on the part of the product that is placed within book parts because the thickness of the profile increases.

In the previously described embodiments the holder, consisting of the writing member and the clamping device comprising a first leg and possibly several leg parts, consists of a, during normal daily use non separating part. It is, however, also conceivable that the holder is constructed out of several parts, as a result of which during normal daily use the clamping device can be detached. As a result of this the clamping device or ‘location indication function’ can be preserved whilst the combined function, in this description consisting of, but not limited to, the ‘marking function’ or ‘writing function’, is executed.

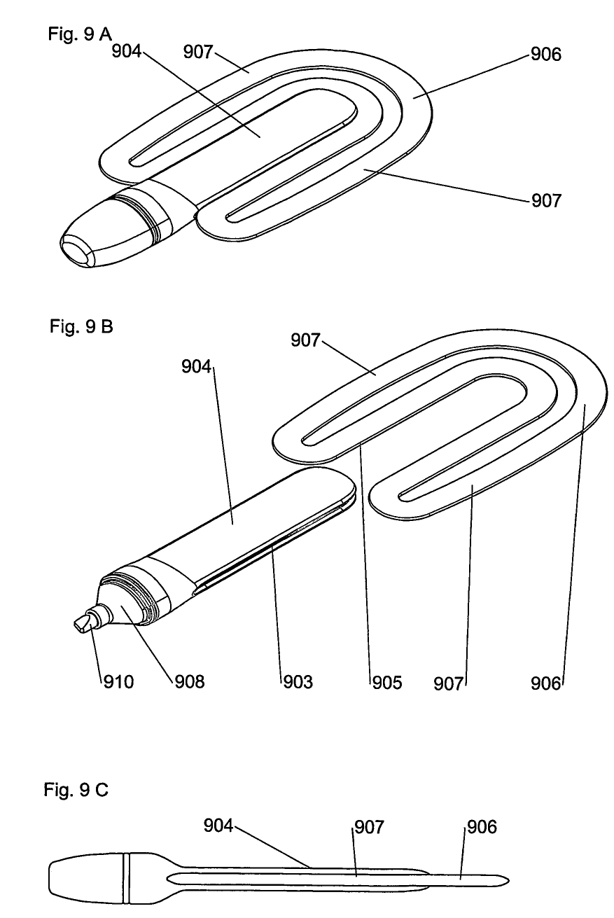

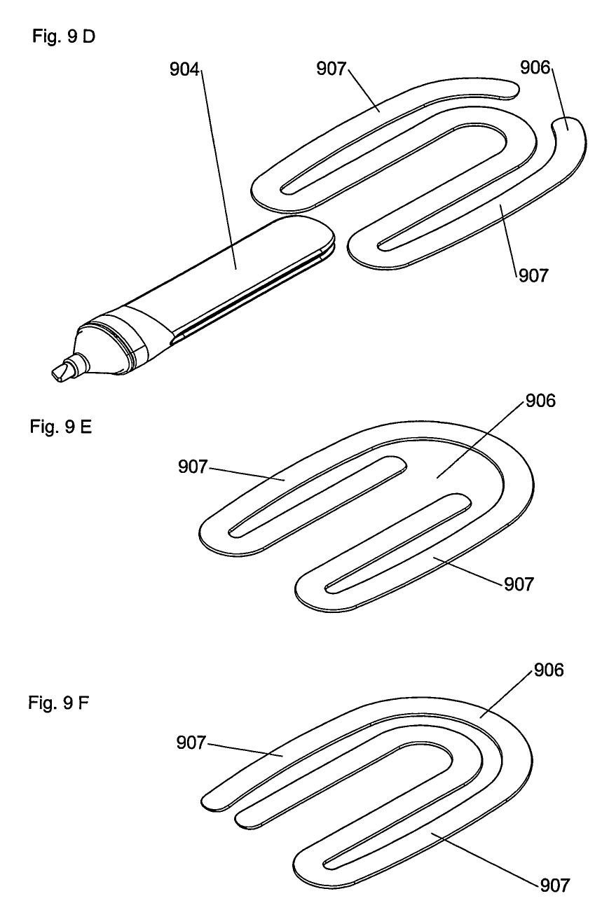

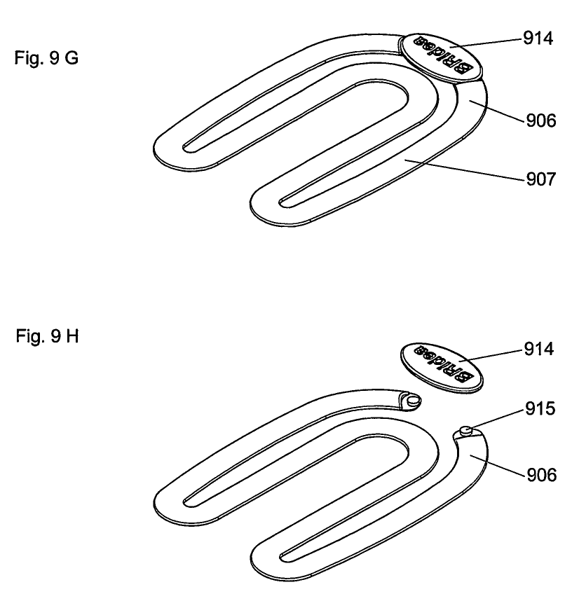

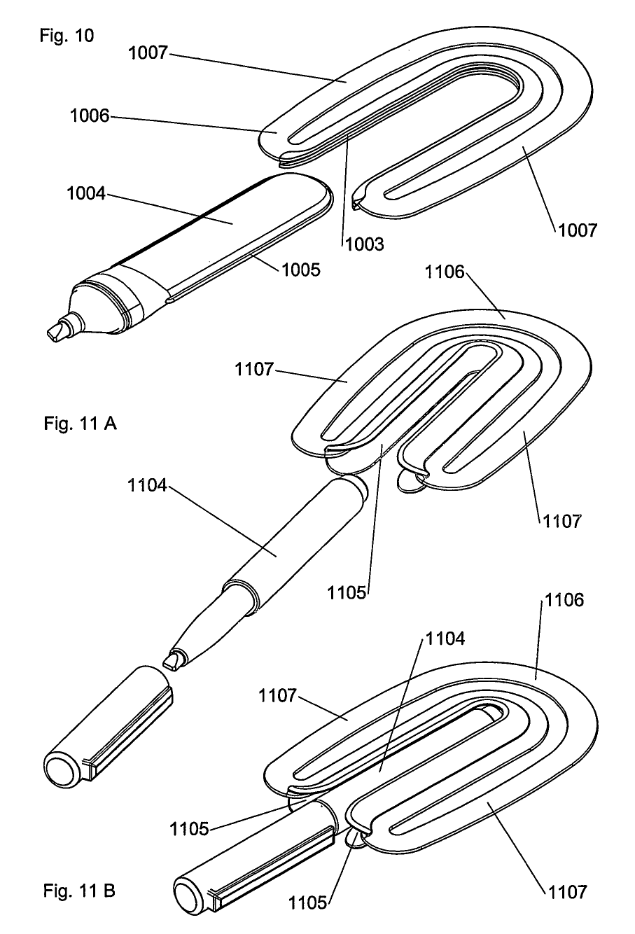

Variations on this fourth embodiment are represented in FIGS. 9A, 9B and 9C and FIG. 10. The writing member consists of two parts which can slide into and out of each other during daily use. Depicted is a groove 903 in the writing member 904 which accommodates a tongue part 905 of the clamping device 906. The tongue part 1005 could also be part of the writing member 1004 and engage in a groove 1003 in the clamping device 1006. The detachable connection between writing member and clamping device is not limited to the mentioned groove/tongue joint. It can also be a matter of a clamping, a male/female joint, in which a protrusion fits into a cavity or opening and thereby causing a temporary connection, fixing or positioning, or other connecting methods or a combination of connecting methods. In the Figures the writing device has a separate cap 912. The function that the cap fulfils can also be integrated in the part that fulfils the clamping function. In this way the cap and the clamping device could be removed in the same motion. A ‘click’ joint which prevents unintended disengaging is also conceivable.

The second non-limiting embodiment, which is described with the non limiting FIGS. 5 and 6, shows a partially opened clamping device. This could also occur in detachable embodiments of the clamping device. FIGS. 9D, E and F show potential, non-limiting variations of a clamping device 906, which can be combined with the writing device 904.

It is conceivable, for any embodiment falling under this invention, that a part of the invention can be personalised for a specific customer. FIGS. 9G and H show a non-limiting variation of a clamping device 906, in this example consisting of several parts, in which a personalised part 914 can simply be combined with a standardised part 915.

It is conceivable that the part which contains the clamping device could also temporarily attach itself to a writing device or provide space for a writing device to attach itself to the clamping device. Because of this a clamping device, apparently meant for use according to the combination described in this application, could be conceivable for separately available writing devices. Writing devices, separately and commercially available on the market or standard, such as widespread, generally elongated, writing devices could be considered. To illustrate this embodiment a non-limiting outer appearance of a writing device is used which shows resemblance to the ‘Parker®’ pen. The detailing of the connection between the clamping device and the writing device is not limited to the shape discussed here. Designs based on the same principles but with different dimensions can cause a connection, apparently meant for use according to the combination described in this application, between a clamping device and a writing device and therefore are within the scope of the invention.

An example of such an embodiment is shown in FIGS. 11A and 11B. In this example an arbitrary writing device 1104 (here in the form of a highlighter marker) can temporarily be attached to a clamping device 1106, comprising a clamping device. This clamping device comprises a body part, which engages in a physical interaction with a part of the writing member, and at least a first leg and in this example also a second leg. The connection between the writing device and the clamping device, which is shown here, could be described as a male part/female part joint, in which one part fits into another part.

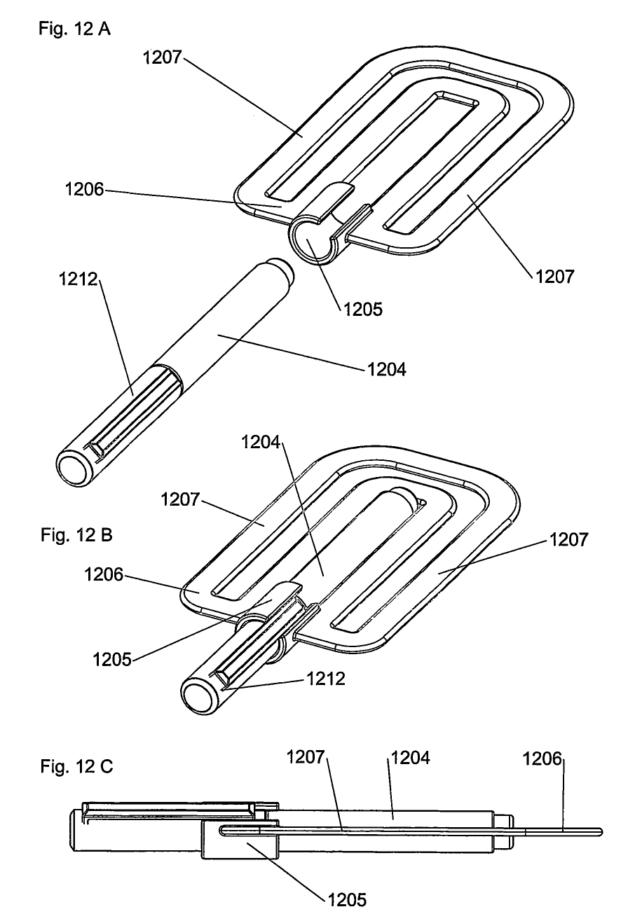

The clamping device, which is depicted in FIGS. 12A, 12B and 12C, is a second non-limiting variation of a clamping device which can be combined with various, standard or commonly available writing devices, as described above. The writing member or the writing device is, at least partially, enclosed and or clamped by, at least parts of, surfaces, grooves, ribs or sides of the clamping device. The partial encircling or enclosing or clamping is caused by body member 1205, which is connected to the clamping device 1206 and interacts with at least a part of the writing member 1204 and in this non-limiting version also with the cap 1212. The first and second leg 1207 are part of the clamping device 1206.

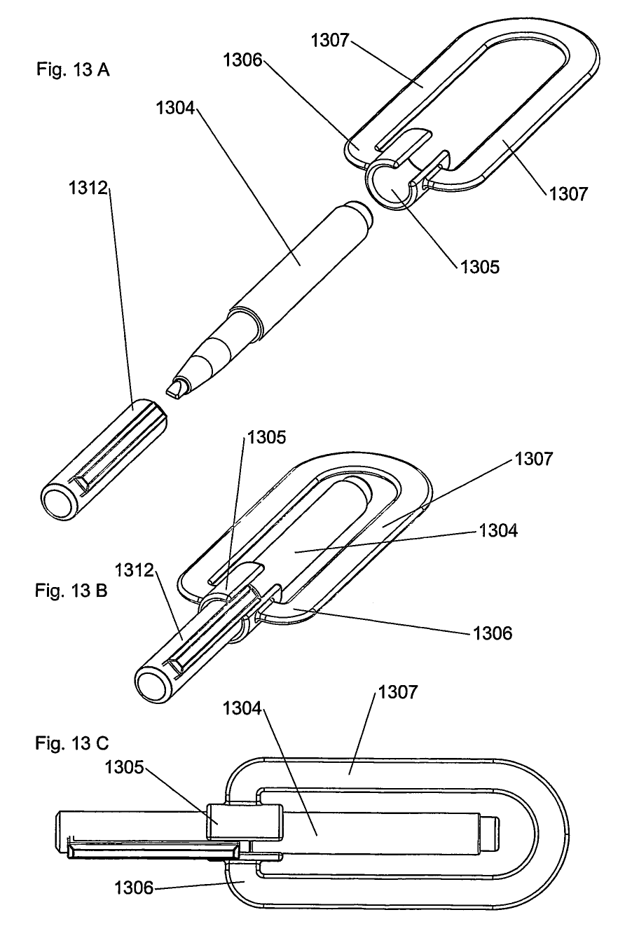

In an embodiment described above (among which FIG. 7) a combination of writing member with clamping device is mentioned, according to the invention, in which these parts can exist of various, individual parts and or materials. FIGS. 13A, 13B and 13C show an embodiment, apparently meant for use according to the combination described in this application, in which the clamping device 1306 is detachable from the writing member 1304. This embodiment of the clamping device could also be connected to separate, common, commercially available writing devices, such as but not limited to above-mentioned examples, by means of a feature (in FIGS. 13A, 13B and 13C the connection 1305) on the clamping device, apparently meant for positioning, or attaching or surrounding the writing device. In this embodiment the clamping device cannot, in absence of or without the combination with the or a suitable writing device, fulfil the function of clamping flat materials.

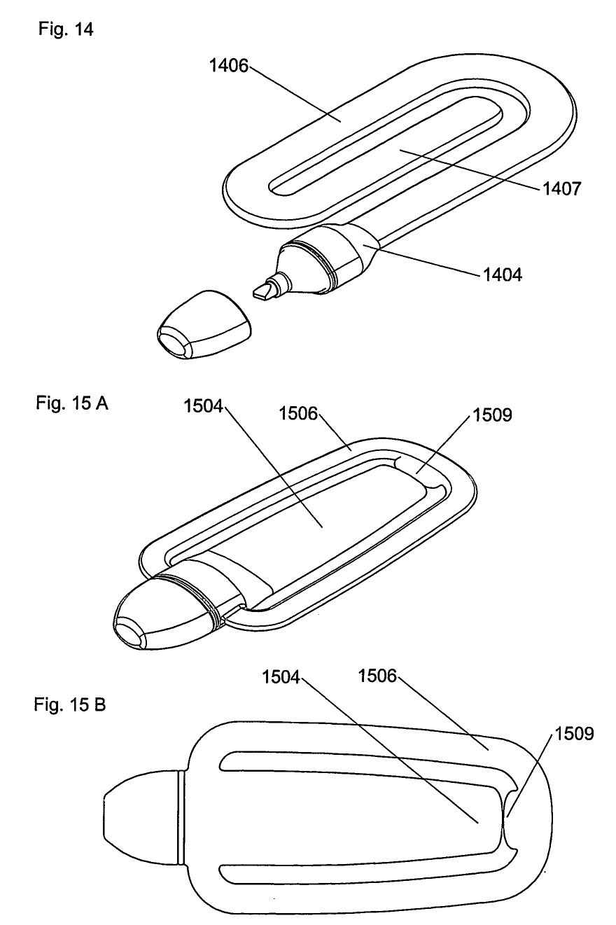

In the above-mentioned embodiments the writing member is roughly situated partially between the first and a second leg. Other versions among which but not limited to FIG. 14 are also conceivable. Here, the first leg 1406 is connected to the end of the writing member 1404, and a second leg 1407 is connected to the other end of the first leg. During the clamping of flat material the second leg, which is located in-between the first leg and the writing member, is positioned on one side of the flat material whilst the writing member and the first leg are positioned on the opposite side of the material. This still is the same invention. The writing member is still an essential part of the clamping device.

When a clamping device is positioned on the strap of a bag there is only a limited frictional force between the clamping device and the strap. This could enable the clamping device to detach too easily. By partially confining the space between the writing member 1504 and the clamping device 1506, e.g. with a bulge 1509 (that is a constriction between the leg part and the edge of the writing member facing the leg part), the strap would detach less easily. An example of this is shown in FIGS. 15A and 15B.

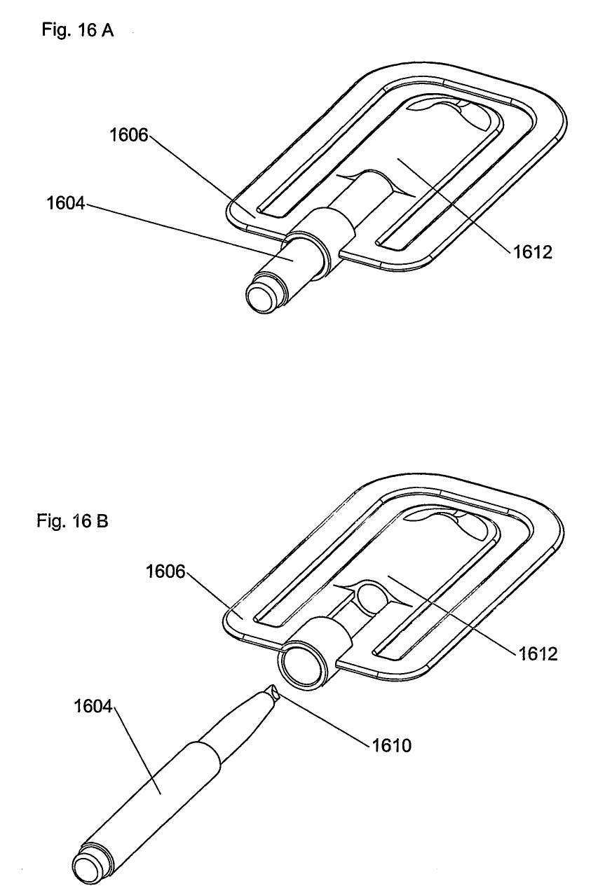

In the previous embodiments the writing tip was located outside of the clamping device and this is also the basic principle, that is the most desirable version of the combination according to this invention. In combination with a clamping device, which is detachable from the writing device, it is however also conceivable or possible that the writing tip is located within the clamping device. Non-limiting embodiments of this concept are shown in FIGS. 16A en 16B en 17A en 17B.

As described above, it is also conceivable that the clamping device 1606, intended for use according to the combination described in this application, has a device 1612 for covering or protecting the writing tip 1610, as is usually performed by a non limiting cap, which is attached to the clamping device. FIGS. 16A and 16B show an embodiment in which the writing member 1604 is detachable from the clamping device and in which the cap is integrated in the clamping device.

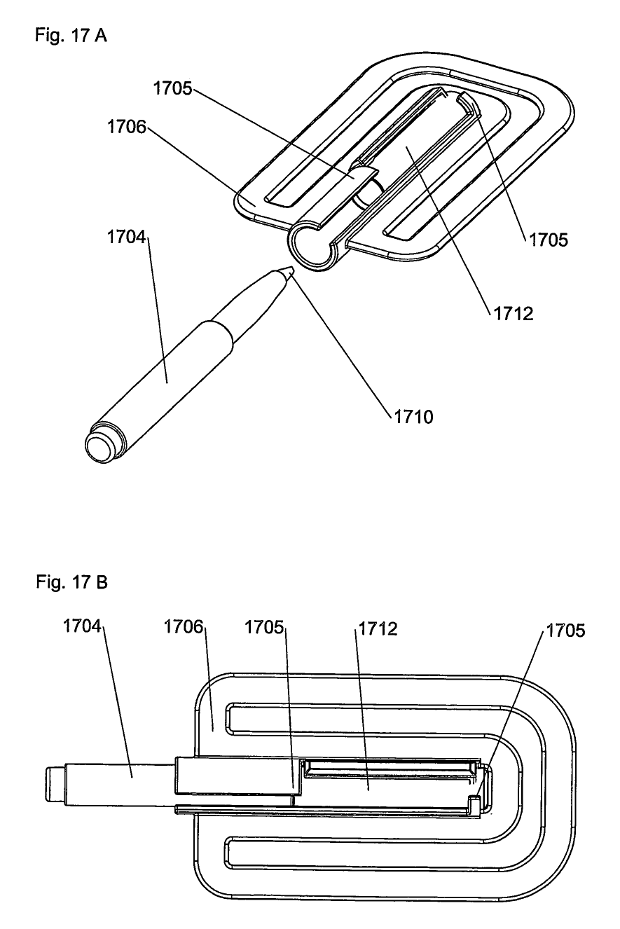

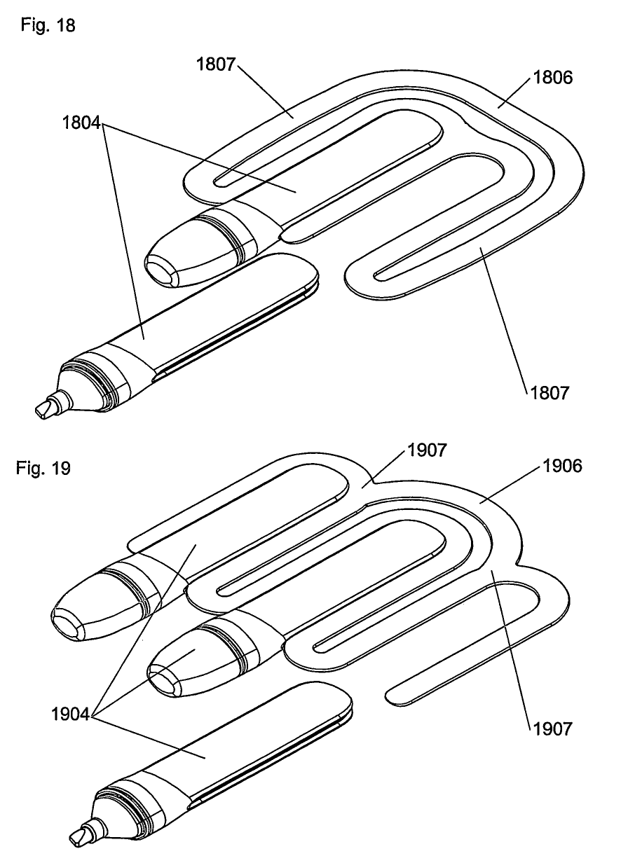

In the above embodiment the cap, that is the device for shielding of the writing tip, was a fixed component of the clamping device. It is however also conceivable that the cap 1712 is a separate part. Whilst removing the writing member 1704 the cap can possibly stay attached to the clamping device 1706 through the previously mentioned connection or clamping parts 1705, or other methods. FIGS. 17A and 17B show an embodiment in which a standard, separately and commercially available writing device is depicted. Nevertheless it could also be a writing device which is supplied in combination with a clamping device.

In the previous embodiments only a single writing device is depicted in the Figures or mentioned in descriptions of the possible embodiments according to the combinations according to this invention. It is, however, also conceivable that the combination could comprise several, possibly different writing devices. This is possible for all previously described embodiments, but is not limited thereto. FIGS. 18 and 19 show embodiments in which several writing devices 1804 and 1904 are attached to a clamping device 1806 and 1906 which in these non limiting embodiments is detachable.

The writing devices do not or not all have to be situated between the leg parts 1907 as depicted in FIG. 19. It is also conceivable that a writing device is combined with e.g. a leg part, be it detachable or fixed, or that the writing device is situated outside of the clamping device completely.

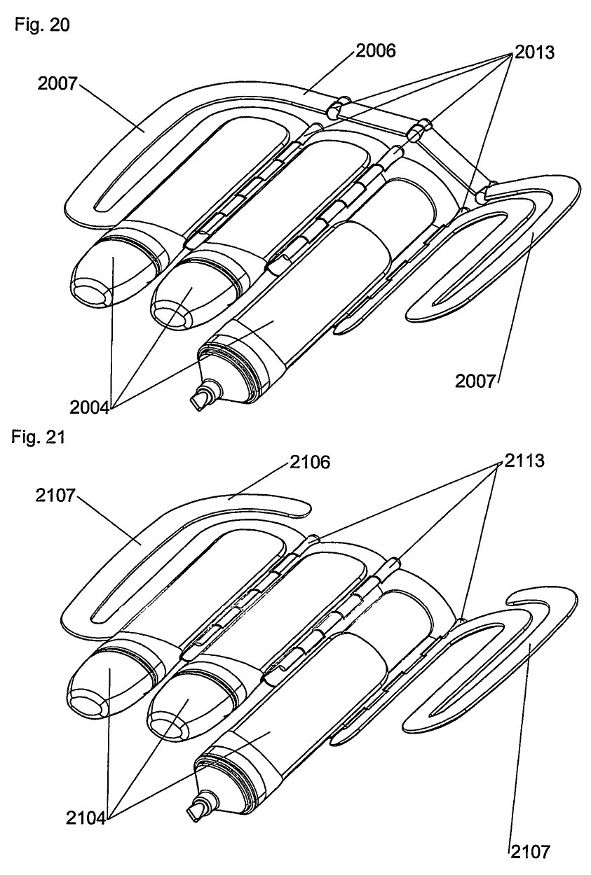

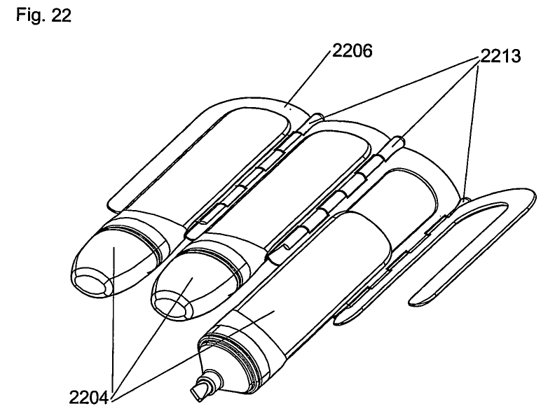

It is conceivable that parts within the combination are connected to hinge or joint devices. This could allow for changes to be made in the shape of a combination, whereby e.g. the outer contour could be reduced. FIGS. 20 and 21 are depicted with clamping devices which can hinge about joint devices 2013 and 2113. Because of this, the combination could be rolled up. The joint devices can be based on various principles, such as but not limited to, film joints, clamp joints or axis joints. The joint device could have a limitation by which the position folded open results in a flat orientation and cannot fold further. Hinging one way would then only be possible. The clamp function is retained thereby. The clamping device can be detailed in various ways, such as the non-limiting embodiment 2106.

A combination such as, but not limited to, FIGS. 18, 19, 20 and 21 can be very interesting for holding together several writing devices. Possibly, the clamping function for paper could be omitted. A clamping function for the various writing devices would remain, as would the bookmark device. FIG. 22 shows an embodiment in which several writing devices are combined with a clamping device 2206, in this non-limiting version also combined with hinge joints 2213.

The above described invention has been illustrated by means of several non-limiting examples of embodiments and variations. It is conceivable that the invention is constructed out of several parts which can be made of different materials and have various forms. The parts can be detachable and fixed, open and closed and movable, such as the open clamping part variations. All conceivable variations of such variables, apparently meant for use according to or possibly usable as the combination described in this application, are possible and therefore are within the scope of the invention as well.

It is conceivable that a writing, drawing or marking device accommodates several exchangeable tips. Therefore embodiments with several tips or combinations of writing, drawing or marking tips also are within the scope of the invention.

General remark: surface texture and the choice of material of the parts of he combination can provide the necessary friction. This applies for all embodiments.

1. Combination of a writing device, comprising a substantially flat writing member which is provided with a writing tip, and at least a clamping device connected to the writing device for clamping the writing member in an edge area of a flat material, the clamping device comprising at least a first elongated leg and a second elongated leg which extend substantially parallel to an edge of the writing member facing thereto, characterised in that the writing member and the clamping device take a fixed position relative to each other.

2. Combination according to claim 1, characterised in that the first leg of the clamping device at an end thereof is connected to the writing member, and in that the second leg of the clamping device at an end thereof is connected to the writing member.

3. Combination according to claim 1, characterized in that the first leg of the clamping device at a first end thereof is connected to the writing member, in that the second leg of the clamping device at a first end thereof is connected to the writing member, and in that a second end of the first leg is connected to a second end of the second leg.

4. Combination according to claim 2, characterised in that the first leg and the second leg of the clamping device are connected to the writing member near the writing tip thereof.

5. Combination according to claim 1, characterised in that the first leg of the clamping device at a first end thereof is connected to the writing member, in that the second leg of the clamping device at an end thereof is connected to a second end of the first leg, and in that a second end of the second leg is free.

6. Combination according to claim 5, characterised in that the first end of the first leg of the clamping device is connected to the writing member near the writing tip thereof.

7. Combination according to claim 5, characterised in that the first end of the first leg of the clamping device is connected to a part of the writing member facing away from the writing tip.

8. Combination according to claim 1, characterised in that the writing member and the clamping device extend substantially in a same plane.

9. Combination according to claim 1, characterised in that the clamping device has a rigid/fixed connection with the writing member.

10. Combination according to claim 1, characterised in that the writing tip is situated outside of the area of the clamping device.

11. Combination according to claim 1, characterised in that the writing member over at least a part of the circumference thereof is provided with a groove for a detachable connection to a tongue part of the clamping device.

12. Combination according to claim 1, characterised in that the writing member over at least a part of the circumference thereof is provided with a tongue part for a detachable connection to a groove of the clamping device.

13. Combination according to claim 1, characterised in that the clamping device or writing member is provided with a part whereby at least a part of the clamping device or writing member thereof can be enclosed for a detachable connection with the other of the clamping device or writing member.

14. (canceled)

15. Combination according to claim 13, characterised in that the enclosure comprises a partial or discontinuous envelopment.

16. Combination according to claim 1, characterised in that the clamping device or writing member, at least surfaces or edges thereof can engage at least a part of other of the clamping device or the writing member for a detachable connection therewith.

17-19. (canceled)

20. Combination according to claim 16, characterised in that the detachable connection comprises a clamping connection.

21. Combination according to claim 1, characterised in that the detachable connection comprises a click feature.

22. Combination according to claim 1, characterised in that the writing tip is situated at least partially within the area of the clamping device.

23. Combination according to claim 1, characterised by a cap for closing off the writing tip.

24. Combination according to claim 23, characterised in that the cap for closing off the writing tip is integrated in the detachable part of the clamping device.

25. Combination according to claim 1, characterised in that one of the clamping device and the writing member comprises an ink reservoir which is connected to the writing tip.

26-32. (canceled)
